(19) United States
(12) Patent Application Publication
(10) Pub. No.: US 2011/0113172 A1
(43) Pub. Date: May 12, 2011

(54) UTILIZATION-ENHANCED SHARED BUS SYSTEM AND BUS ARBITRATION METHOD

(75) Inventors: MING-DER SHIEH, Tainan (TW); DER-WEI YANG, Tainan (TW); TZUNG-REN WANG, Tainan (TW)

(73) Assignees: HIMAX TECHNOLOGIES LIMITED, TAINAN (TW); NCKU RESEARCH AND DEVELOPMENT FOUNDATION, Tainan (TW)

(21) Appl. No.: 12/617,659

(22) Filed: Nov. 12, 2009

(51) Int. Cl. G06F 13/362

(52) U.S. Cl. 710/113

(57) ABSTRACT

A utilization-enhanced shared bus system and bus arbitration method are disclosed. An arbiter arbitrates among multiple masters according to active requests sent from the masters. The arbiter sends a passive request to one of the masters in an idle period of the shared bus according to respective status of the masters. Accordingly, the master that receives the passive request may access a shared resource in the idle period.

### BACKGROUND OF THE INVENTION

1. Field of the Invention

The present invention generally relates to a shared bus system, and more particularly to a bus arbiter in the context of a shared bus system.

2. Description of the Prior Art

A bus arbiter is used in a shared bus system to resolve bus contention, in which more than one master or agent on the bus attempts to use the bus and its associated resource, such as a shared memory, at the same time. To the extent resolution of the bus contention may be resolved, however, such is typically at a cost of degrading system utilization. FIG. 1A shows an exemplary timing diagram according to a conventional bus arbiter. Specifically, a master 1 sends a request to a bus arbiter (not shown) at time T1 in order to write data to a shared memory (not shown). The master 1 proceeds with the data writing until time T2, at which time the request from the master 1 becomes inactive. Concurrently, as shown in FIG. 1B, the first-in first-out (FIFO) register of another master, e.g., the master 2, is not full at the time T1 and the time T2. Afterwards, at time T3, the FIFO of the master 2 finally becomes full, and a request is then sent from the master 2 to the bus arbiter for requesting the shared bus and the shared memory. The system thus encounters an idle period, such as the period from T2 to T3, during which no request has been issued therefore causing the bus to be idle. Such idle periods can degrade the utilization of the bus and the performance of the entire system.

For the reason that conventional bus systems tend to under utilize bus resources, a need has arisen to propose a novel scheme to increase the utilization and performance of performance-compromised bus systems.

### SUMMARY OF THE INVENTION

In view of the foregoing, it is an object of the embodiments of the present invention to provide a utilization-enhanced arbiter and an arbitration method for shortening the bus idle period, thereby increasing bus utilization and system performance.

According to one embodiment, a utilization-enhanced arbiter arbitrates among multiple masters according to at least one active request sent from the masters, thereby deciding which one of the masters has a right to use a shared bus in order to access a resource. The arbiter sends a passive request to one of the masters in an idle period, during which no data transaction occurs on the shared bus, according to respective status of the masters. Accordingly, the master that receives the passive request may access the resource in the idle period, thereby shortening the idle period and increasing bus utilization and system performance.

### BRIEF DESCRIPTION OF THE DRAWINGS

FIG. 1A shows an exemplary timing diagram according to a conventional bus arbiter;

FIG. 1B shows the status of a FIFO register at multiple points in time;

FIG. 2 shows a shared bus system according to one embodiment of the present invention;

FIG. 3 shows a flow diagram of utilization-enhanced bus arbitration among multiple masters on a shared bus according to an embodiment of the present invention;

FIG. 4A shows a FIFO register and a refined threshold for a writing phase; and

FIG. 4B shows a FIFO register and a refined threshold for a reading phase.

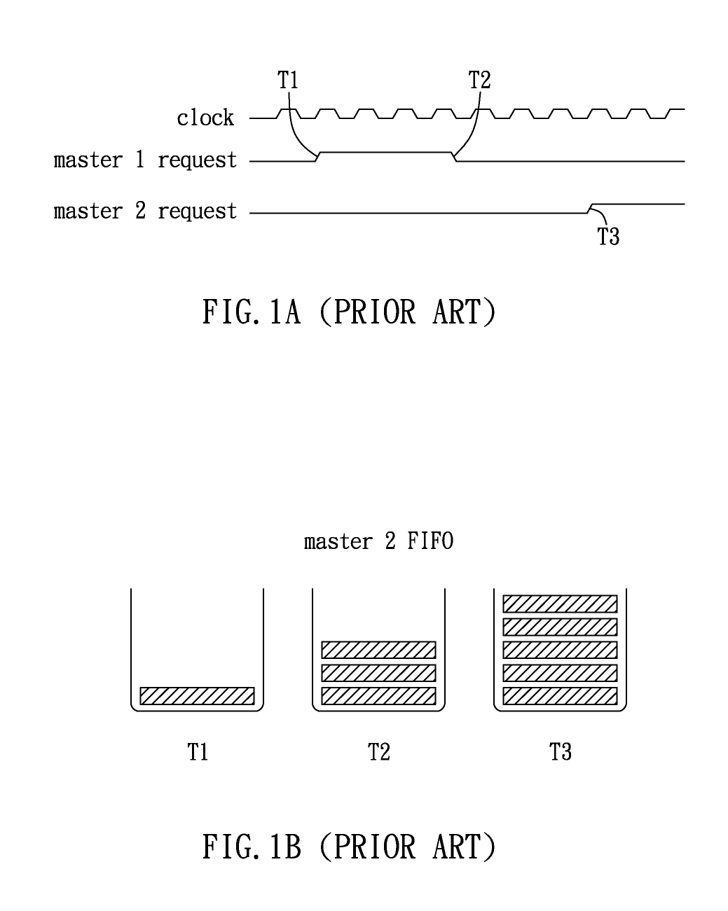

### DETAILED DESCRIPTION OF THE INVENTION

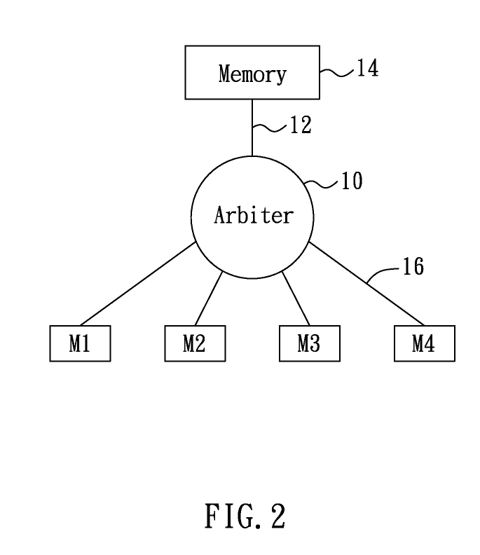

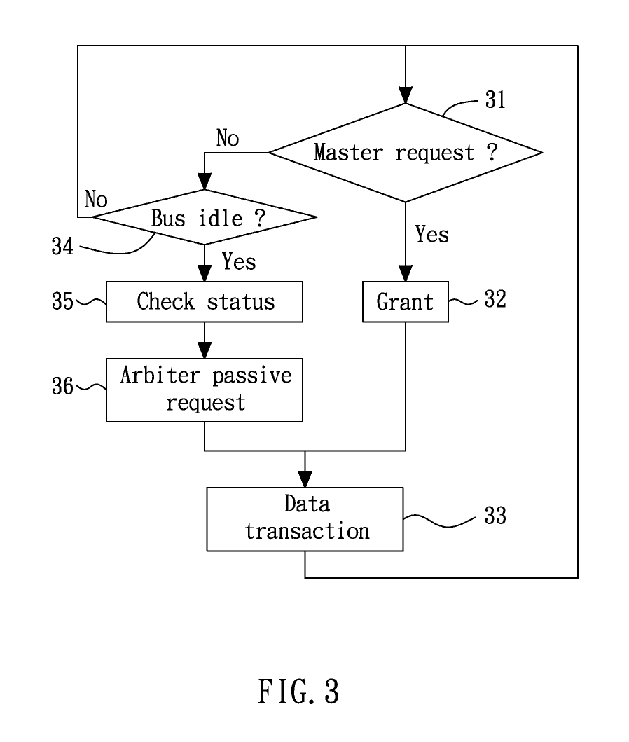

FIG. 2 shows a shared bus system according to one embodiment of the present invention. In this exemplary system, a utilization-enhanced arbiter 10 arbitrates among multiple (e.g., two or more) masters (e.g., M1, M2, etc.) or agents to decide (e.g., make a decision concerning) which one has the exclusive right to use a shared bus 12 and its associated resource such as a shared memory 14. Although one arbiter (i.e., the arbiter 10) is demonstrated in the example, it is appreciated that more than one arbiter may be adopted in the shared bus system. FIG. 3 shows a flow diagram of utilization-enhanced bus arbitration among multiple masters on the shared bus 12 according to an embodiment of the present invention. It is appreciated that the sequence of performing the shown steps may be altered, some of the steps may be omitted, or further steps may be added. The system illustrated in FIG. 2 and the method demonstrated in FIG. 3 may be applied to any arbitration policies such as fixed-priority arbitration or round-robin arbitration.

According to the embodiment, in step 31, the arbiter 10 determines whether at least one (active) request has been sent from one of the masters (e.g., M1, M2, etc.). For example, a master usually sends a write request whenever its associated (write) first-in first-out (FIFO) register becomes full or almost full (e.g., full/almost-full). On the other hand, a master usually sends a read request whenever its associated (read) FIFO register becomes empty or almost empty (e.g., empty/almost-empty). The mentioned FIFO register is usually located on the respective master's side. Generally speaking, a full/almost full (write) FIFO register indicates that the data prepared for writing to the shared memory 14 are ready for transaction, and an empty/almost empty (read) FIFO register indicates that more data are demanded to be read from the shared memory 14. As used herein, the term “almost full” indicates the data occupancy in the FIFO register being higher than an almost-full threshold value but lower than a full occupancy, and the term “almost empty” indicates the data occupancy in the FIFO register being lower than an almost-empty threshold value but higher than an empty occupancy. Although the FIFO register is used here to indicate the data availability in a master, it is appreciated that the data availability, or status in general, of the master may be represented by another scheme equivalent in function.

If it is determined that at least one request is present at the moment, the arbiter 10 grants the bus 12 privilege to a (e.g., one) master that, for example, sends a request earlier or has a higher priority (step 32). A communication link (e.g., of wires) is coupled between each master and the arbiter, with each link comprising, for instance, a request link for carrying one or both of the write and read requests of the corresponding master and a grant link for carrying a grant. In the embodiment, one pair 16 of request and grant wires is devoted to one (e.g., each) master, for carrying one or both of the request signal and the grant signal, respectively. Afterwards, a data transaction (e.g., writing data or reading data to/from the memory 14) proceeds in step 33.

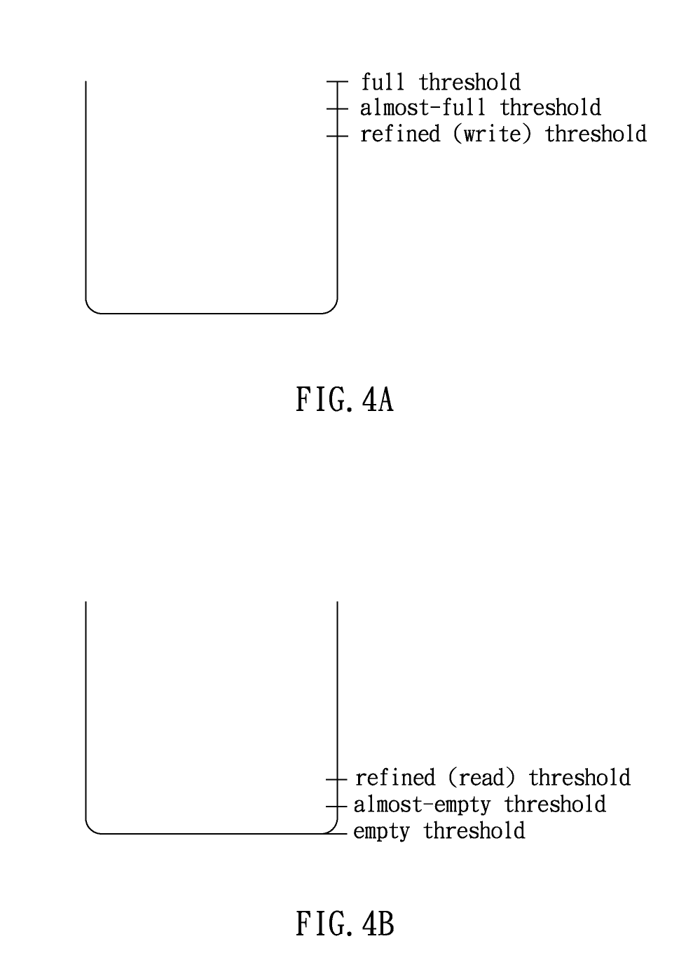

If it is determined in step 31 that no request is present at the moment and the bus 12 is idle (step 34), the arbiter 10 then checks the respective status of the masters (e.g., of each master) in step 35. Specifically, in the embodiment the arbiter 10 determines whether the (e.g., each) master has reached a predetermined (e.g., an arbiter-defined) refined threshold, which is usually distinct from the full/almost-full threshold and the empty/almost-empty threshold as defined by the respective master and/or as discussed in connection with step 31. FIG. 4A shows a (write) FIFO register for which a refined (write) threshold has been defined by the arbiter 10 along with the full/almost-full threshold defined by the master. FIG. 4B shows a (read) FIFO register for which a refined (read) threshold has been defined by the arbiter 10 along with the empty/almost-empty threshold defined by the master. It is noted that in the embodiment the refined (write) threshold has a value lower than the full/almost-full threshold, and the refined (read) threshold has a value higher than the empty/almost-empty threshold. It is appreciated that the refined threshold may be a fixed value or an adaptive (or otherwise unfixed) value. Moreover, the threshold values for the masters may be different from each other. In another embodiment, the arbiter 10 may check the master status without actually interacting with the masters. For example, the status of some masters, particularly those with periodic behavior, may be expected (e.g., anticipated) by the arbiter 10 according to recorded and/or calculated data on the arbiter's side.

Subsequently, in step 36, the arbiter 10 sends a passive request to one of the masters according to the checked status of the masters, followed by proceeding with the data transaction (step 33). In the embodiment the arbiter 10 sends the passive request to the master that has reached the refined threshold. It is noted that the passive request may be sent via a communication link (e.g., wire) that is the same as the grant wire of the request/grant wire pair 16, or via another (e.g., dedicated) wire. For instance, a dedicated wire may be coupled in each pair of wires for carrying the passive request.

According to the embodiment disclosed above, the arbiter 10 may trigger the data transaction in an active manner in a bus idle period, thereby increasing the occurrence probability of data transaction, shortening the bus idle period, and increasing bus utilization and system performance.

Although specific embodiments have been illustrated and described, it will be appreciated by those skilled in the art that various modifications may be made without departing from the scope of the present invention, which is intended to be limited solely by the appended claims.

What is claimed is:

1. A utilization-enhanced shared bus system, comprising:
a shared bus, through which a plurality of masters share a resource; and
an arbiter configured to arbitrate among the plurality of masters to decide which one of the masters has a right to use the shared bus in order to access the resource;
wherein the arbiter is configured to send a passive request to one of the masters, in an idle period of the shared bus, according to respective status of the masters, such that the master that receives the passive request may access the resource in the idle period.

2. The system of claim 1, wherein the resource comprises a memory.

3. The system of claim 1, wherein the system is configured to determine the status of the master according to data occupancy in a first-in first-out (FIFO) register.

4. The system of claim 3, wherein the arbiter is configured to define a refined threshold for the FIFO register in a manner that the arbiter sends the passive request to the master that possesses the status of reaching the refined threshold.

5. The system of claim 4, wherein the refined threshold is a refined write threshold for a writing phase or a refined read threshold for a reading phase.

6. The system of claim 5, wherein the master is configured to send a write request to the arbiter for writing data to the resource whenever data occupancy of the corresponding FIFO register becomes full or reaches an almost-full threshold, and the master sends a read request to the arbiter for reading data from the resource whenever the data occupancy of the corresponding FIFO register becomes empty or reaches an almost-empty threshold.

7. The system of claim 6, wherein the refined write threshold is lower than the almost-full threshold, and the refined read threshold is higher than the almost-empty threshold.

8. The system of claim 6, further comprising a plurality of pairs of wires, each said pair being coupled between each said master and the arbiter, wherein each said pair comprises a request wire for carrying one or more of the write and read requests and a grant wire for carrying a grant.

9. The system of claim 8, wherein each said pair of wires further comprises a dedicated wire for carrying the passive request.

10. The system of claim 1, wherein the status of the master is data recorded in or calculated by the arbiter.

11. A utilization-enhanced bus arbitration method, comprising:
arbitrating among a plurality of masters by an arbiter according to at least one active request sent from the masters, thereby deciding which one of the masters has a right to use a shared bus in order to access a resource; and
sending by the arbiter a passive request to one of the masters in an idle period, during which no data transaction occurs on the shared bus, according to respective status of the masters, whereby the master that receives the passive request may access the resource in the idle period.

12. The method of claim 11, wherein the resource comprises a memory.

13. The method of claim 11, wherein the status of the master is determined according to data occupancy in a first-in first-out (FIFO) register.

14. The method of claim 13, wherein the arbiter defines a refined threshold for the FIFO register in a manner of the arbiter sending the passive request to the master that possesses the status of reaching the refined threshold.

15. The method of claim 14, wherein the refined threshold is a refined write threshold for a writing phase or a refined read threshold for a reading phase.

16. The method of claim 15, wherein the master sends a write request to the arbiter for writing data to the resource whenever data occupancy of the corresponding FIFO register becomes full or reaches an almost-full threshold, and the master sends a read request to the arbiter for reading data from the resource whenever the data occupancy of the corresponding FIFO register becomes empty or reaches an almost-empty threshold.

17. The method of claim 16, wherein the refined write threshold is lower than the almost-full threshold, and the refined read threshold is higher than the almost-empty threshold.

18. The method of claim 16, further comprising a step of coupling a plurality of pairs of wires, each said pair being coupled between each said master and the arbiter, wherein each said pair comprises a request wire and a grant wire for carrying one or more of the write and read requests and a grant, respectively.

19. The method of claim 18, in each said pair of wires, further comprising coupling a dedicated wire for carrying the passive request.

20. The method of claim 11, wherein the status of the master is data recorded in or calculated by the arbiter.
